(19) United States
(12) Patent Application Publication
(10) Pub. No.: US 2019/0135226 A1
(43) Pub. Date: May 9, 2019

(54) SEATBELT DEVICE

(71) Applicant: KABUSHIKI KAISHA TOKAI-RIKA-DENKI-SEISAKUSHO, Aichi (JP)

(72) Inventors: Ryo MAEKAWA, Aichi (JP); Akira SUMIYASHIKI, Aichi (JP)

(21) Appl. No.: 16/099,076

(22) PCT Filed: Apr. 28, 2017
(86) PCT No.: PCT/JP2017/017088

§ 371 Date: Nov. 5, 2018

(30) Foreign Application Priority Data
May 12, 2016 (JP) 2016-096396

(51) Int. Cl. B60R 22/20; B60R 22/46

(52) U.S. Cl. CPC B60R 22/20; B60R 2022/208; B60R 2022/207; B60R 22/46

(57) ABSTRACT

In a seatbelt device, a guide face of a guide section of a base member of a support device is configured by a flat inclined face that is displaced toward a seat lower side on progression toward a seat left side. Accordingly, a slider is capable of sliding smoothly toward a seat right side end of a permitted slide range of the slider under urging force of a compression coil spring when an increase in tension on a webbing due to actuation of a motor in a vehicle emergency is released.

### CROSS-REFERENCE TO RELATED APPLICATIONS

The present application is a U.S. National Phase of PCT/JP2017/017088 filed on Apr. 28, 2017, claiming priority to Japanese Patent Application No. 2016-096396 filed May 12, 2016. The disclosure of the PCT Application is hereby incorporated by reference into the present application.

### TECHNICAL FIELD

The present invention relates to a seatbelt device in which an upper side end portion of a shoulder webbing is capable of moving.

### BACKGROUND ART

Seatbelt devices provided with a shoulder webbing exist in which an upper side end portion of the shoulder webbing, disposed at the upper side on one width direction side of a vehicle seat, is moved toward the other width direction side of the seat in a vehicle emergency (see the specification of German Patent Application Laid-Open No. 102013010770, for example). In a vehicle emergency, it is desirable for the upper side end portion of the shoulder webbing to be close to the body of an occupant in the seat width direction. However, during normal use outside of a vehicle emergency, disposing the upper side end portion of the shoulder webbing close to the body of the occupant could cause discomfort to the occupant as a result of the upper side end portion of the shoulder webbing contacting the body of the occupant.

### SUMMARY OF INVENTION

### Technical Problem

In consideration of the above circumstances, an object of the present invention is to obtain a seatbelt device in which an upper side end portion of a shoulder webbing is able to move along a seat width direction toward the body of an occupant in a vehicle emergency, enabling the upper side end portion of the shoulder webbing to be separated from the body of the occupant during normal use outside of a vehicle emergency.

### Solution to Problem

A seatbelt device of a first aspect of the present disclosure includes: a shoulder webbing that spans from an upper side on one width direction side of a seat of a vehicle to a lower side on another width direction side of the seat in a fitted state of the shoulder webbing over the body of an occupant; a support section that supports an upper side end portion of the shoulder webbing at the upper side on the one width direction side of the seat; and a guide section that includes a flat or curved guide face inclined toward the lower side on progression from the one width direction side toward the other width direction side, that is configured so as to enable the support section to move back and forth along the guide face, and that is configured such that the support section moves toward the other width direction side in a vehicle emergency.

In the seatbelt device of the first aspect of the present disclosure, the guide face of the guide section is configured by a flat or curved face inclined toward the lower side on progression from the one width direction side toward the other width direction side, and the support section that supports the upper side end portion of the shoulder webbing is capable of moving back and forth along the guide face of the guide section. The support section is moved toward the lower side on the other width direction side along the guide face of the guide section in a vehicle emergency. The upper side end portion of the shoulder webbing that is being supported by the support section thereby moves toward the body of the occupant.

Since the support section is capable of moving back and forth along the guide face of the guide section, when the support section has moved toward the lower side on the other width direction side along the guide face of the guide section, the support section is capable of moving toward the upper side on the other width direction side along the guide face of the guide section. This enables the upper side end portion of the shoulder webbing that is supported by the support section to move away from the body of the occupant.

A seatbelt device of a second aspect of the present disclosure is the seatbelt device of the first aspect, wherein the support section is moved toward the other width direction side by increased tension on the shoulder webbing in a vehicle emergency, and the support section is subsequently moved toward the one width direction side by a reduction in the tension on the shoulder webbing that was increased in the vehicle emergency.

In the seatbelt device of the second aspect of the present disclosure, the tension on the shoulder webbing is increased in a vehicle emergency, and the support section is moved by this increased tension on the shoulder webbing. A dedicated drive section for moving the support section is thereby rendered unnecessary.

A seatbelt device of a third aspect of the present disclosure is the seatbelt device of the first or the second aspect, wherein the support section is urged toward the one width direction side by urging force of an urging section and retained at the upper side on the one width direction side of the seat, and the support section is moved toward the other width direction side by being applied with a force acting against the urging force of the urging section, and moved toward the one width direction side by the urging force of the urging section when the force is released.

In the seatbelt device of the third aspect of the present disclosure, the support section is urged toward the one width direction side by the urging force of the urging section, and the support section is moved toward the other width direction side by a force acting against the urging force of the urging section being applied to the support section. When the force on the support section acting against the urging force of the urging section is released, the support section is moved toward the one width direction side by the urging force of the urging section. This enables the support section to be returned to the one width direction side by the cessation of tension being applied to the shoulder webbing, such as in cases in which a vehicle emergency state has been avoided.

A seatbelt device of a fourth aspect of the present disclosure is the seatbelt device of the third aspect, wherein the urging force of the urging section is increased by moving the support section toward the other width direction side, and the support section is restricted from moving toward the other width direction side before the urging force of the urging section is at its greatest.

In the seatbelt device of the fourth aspect of the present disclosure, the support section is restricted from moving toward the other width direction side before the urging force of the urging section, which is increased by movement of the support section toward the other width direction side, is at its greatest. This enables the urging force of the urging section to be suppressed from reaching the greatest urging force.

### Advantageous Effects of Invention

As explained above, in the seatbelt device according to the present invention, the upper side end portion of the shoulder webbing is able to move along the seat width direction toward the body of an occupant in a vehicle emergency, enabling the upper side end portion of the shoulder webbing to be separated from the body of the occupant during normal use outside of a vehicle emergency.

### BRIEF DESCRIPTION OF DRAWINGS

FIG. 1 is a front view of a seatbelt device according to an exemplary embodiment of the present invention.

FIG. 2 is a front view corresponding to FIG. 1, illustrating a state in which a support section of a support device has been slid toward a seat lower left side (another side in a seat width direction).

### DESCRIPTION OF EMBODIMENTS

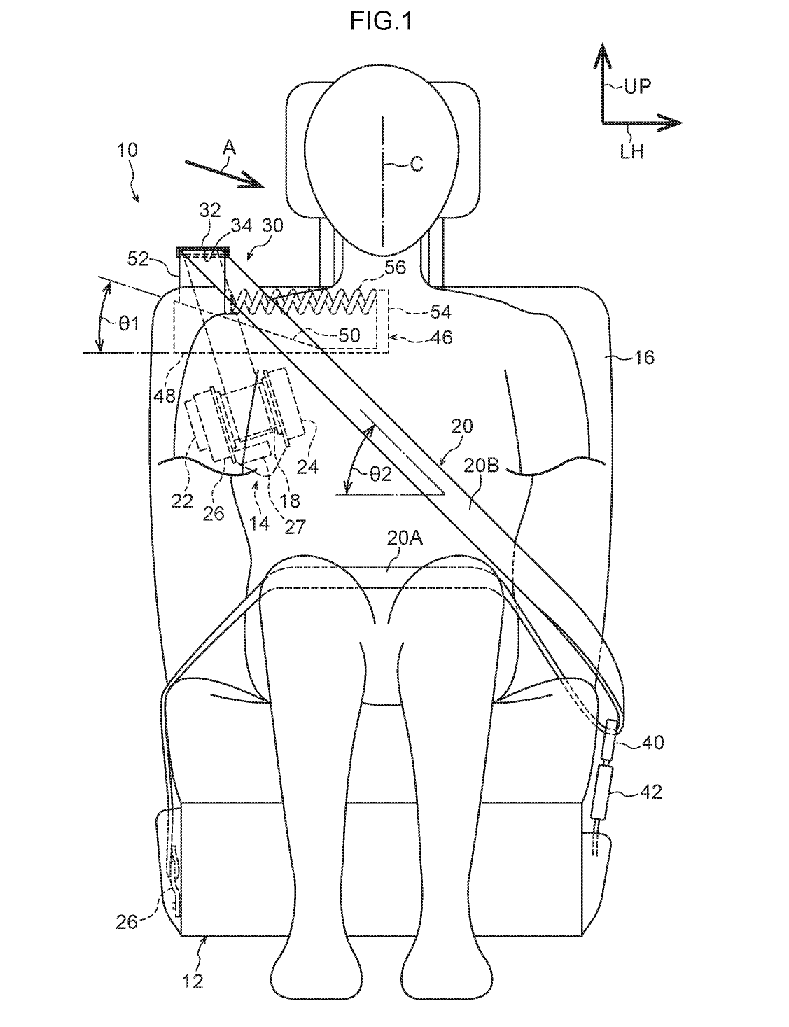

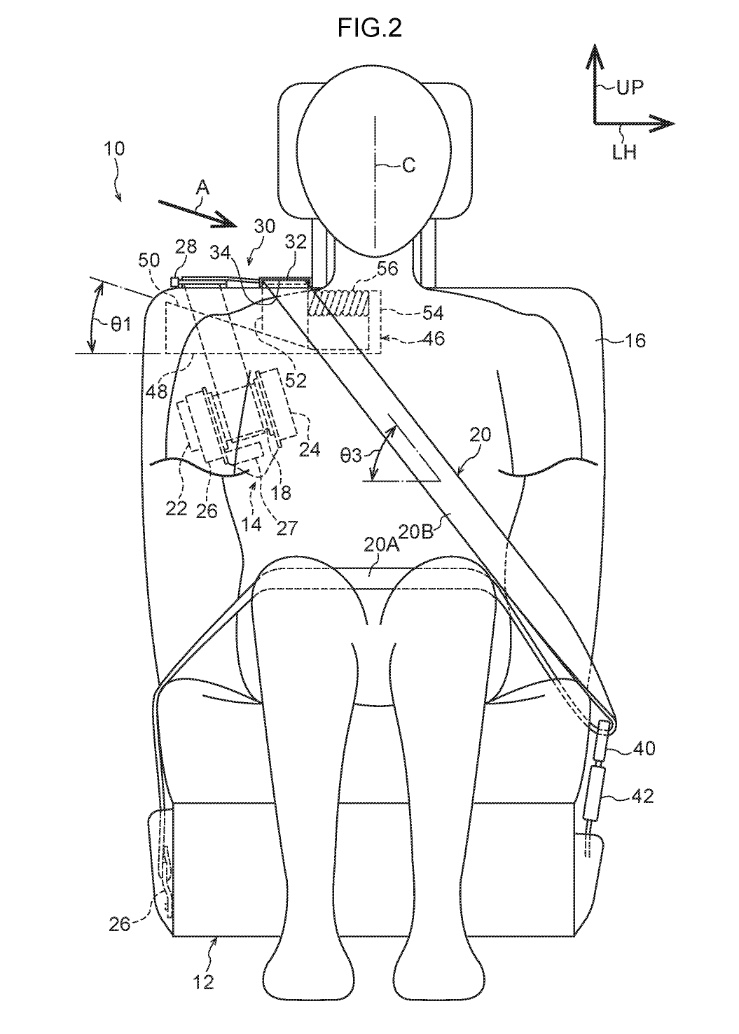

Explanation follows regarding an exemplary embodiment of the present invention, with reference to FIG. 1 and FIG. 2. In the drawings, the arrow LH indicates the left side of a vehicle seat 12 applied with a seatbelt device 10 (another width direction side of the seat 12), and the arrow UP indicates the seat upper side.

Configuration of Present Exemplary Embodiment

As illustrated in FIG. 1, the seatbelt device 10 according to the present exemplary embodiment includes a webbing take-up device 14. The webbing take-up device 14 is disposed inside a seatback 16 of the seat 12. The webbing take-up device 14 includes a spool 18. The spool 18 is formed in a substantially circular cylinder shape, and the spool 18 is capable of rotating about a central axis. A length direction base end portion of a webbing 20 of the seatbelt device 10 is anchored to the spool 18. The webbing 20 is formed in an elongated belt shape. When the spool 18 is rotated in a take-up direction, the webbing 20 is taken up onto the spool 18 from the length direction base end side.

The webbing take-up device 14 also includes a spool urging mechanism 22. The spool urging mechanism 22 includes a spool urging spring, such as a spiral spring, and the spool 18 of the webbing take-up device 14 is urged in the take-up direction by the spool urging spring of the spool urging mechanism 22.

The webbing take-up device 14 further includes a locking mechanism 24. The locking mechanism 24 is actuated in a vehicle emergency such as a vehicle collision. When the locking mechanism 24 actuates, the spool 18 is restricted from rotating in a pull-out direction, this being the opposite direction to the take-up direction, by the locking mechanism 24. The webbing 20 is thus restricted from being pulled out from the spool 18 in a vehicle emergency. The webbing take-up device 14 also includes a pre-tensioner 26, serving as a tension application section. The pre-tensioner 26 is actuated in a vehicle emergency such as a vehicle collision. When the pre-tensioner 26 is actuated, the spool 18 is rotated in the take-up direction by the pre-tensioner 26, thereby taking up the webbing 20 onto the spool 18 in a vehicle emergency.

The webbing take-up device 14 also includes a motor 27. The motor 27 includes an output shaft (not illustrated in the drawings). The output shaft of the motor 27 is coupled to the spool 18 through a rotation force transmission section, such as a gear train configured including a clutch. The motor 27 is electrically connected to a motor driver, serving as a controller, and an ECU (not illustrated in the drawings). The ECU is electrically connected to a front monitoring device (not illustrated in the drawings) such as a millimeter-wave radar. The front monitoring device detects the distance to other vehicles or obstacles in front of the vehicle in which the seatbelt device 10 is installed. When the distance to another vehicle or an obstacle in front as detected by the front monitoring device becomes a predetermined value or lower, the ECU determines that a vehicle collision predicted state has arisen, a vehicle collision being one type of vehicle emergency, and the ECU drives forward rotation of the motor 27. The forward rotation drive of the motor 27 actuates the clutch of the rotation force transmission section, and forward rotation drive force of the motor 27 is transmitted to the spool 18. The spool 18 is thereby rotated in the take-up direction, and the webbing 20 is taken up onto the spool 18.

The webbing 20 is extended from the spool 18 toward a seat upper right side and pulled out at a seat upper side of the seatback 16 of the seat 12. As illustrated in FIG. 2, a pulley 28 is provided at a seat upper side end portion of the seatback 16 of the seat 12. The pulley 28 has a rod-shaped profile with a circular cross-section. An axial center direction of the pulley 28 runs along the seat left-right direction. The pulley 28 is capable of rotating about its axial center. The webbing 20 that has been pulled out at the seat upper side of the seatback 16 is entrained around the pulley 28, such that the part of the webbing 20 on a length direction leading end side of the pulley 28 extends toward the seat front side.

A support section 32, serving as a support section of a support device 30, is provided at the seat front side of the pulley 28. The support section 32 is formed with an elongated hole 34. The length direction of the elongated hole 34 extends in the seat left-right direction, and the webbing 20 passes through the elongated hole 34 in the support section 32 from the seat rear side of the support section 32.

A length direction leading end portion of the webbing 20 that has passed through the elongated hole 34 of the support section 32 is anchored to an anchor plate 26. The anchor plate 26 is provided at a seat lower side of a seat cushion 38 of the seat 12, on the seat right side of the seat 12 (one width direction side of the seat 12). The anchor plate 26 is fixed to a vehicle body side portion such as a seat frame of the seat 12 or the vehicle body of the vehicle.

A tongue 40 is provided to the webbing 20 between the support section 32 of the support device 30 and the anchor plate 26. The tongue 40 is capable of moving along the length direction of the webbing 20. A buckle 42 is provided at a seat left side of the seat 12. As illustrated in FIG. 1, in a state in which the webbing 20 is wrapped across the seat front side of the body of an occupant 44 sitting in the seat 12, the tongue 40 is engaged with the buckle 42 and the tongue 40 is retained by the buckle 42, thereby placing the webbing 20 in a fitted state over the body of the occupant 44.

The part of the webbing 20 between the tongue 40 and the anchor plate 26 in the fitted state of the webbing 20 over the body of the occupant 44 configures a lap webbing 20A. The pelvic region of the occupant 44 is restrained by the lap webbing 20A. The part of the webbing 20 between the support section 32 of the support device 30 and the tongue 40 in the fitted state of the webbing 20 over the body of the occupant 44 configures a shoulder webbing 20B. The shoulder webbing 20B restrains the body of the occupant 44 from the shoulder on the seat right side to the seat left side of the pelvic region of the occupant 44.

The support device 30 includes a base member 46. The base member 46 is provided inside a seat upper side portion of the seatback 16 of the vehicle seat 12. The base member 46 includes a guide section 48, serving as a guide section. A face on the seat upper side of the guide section 48 configures a guide face 50. The guide face 50 is a flat inclined face displaced toward the seat lower side on progression toward the seat left side. A guide groove (not illustrated in the drawings) is formed in the guide section 48 of the base member 46. The length direction of the guide groove in the guide section 48 runs in the seat left-right direction, and the guide groove opens onto the guide face 50 of the guide section 48.

The guide section 48 of the base member 46 is further provided with a slider 52. A seat lower side portion of the slider 52 engages with the guide groove in the guide section 48 of the base member 46, such that movement of the slider 52 in the seat front-rear direction is restricted by the guide section 48. An angle of incline θ1 of the guide face 50 with respect to the seat left-right direction is set to less than 45°, such that a movement amount of the slider 52 in the seat left-right direction guided by the guide face 50 of the guide section 48 of the base member 46 is greater than a movement amount of the slider 52 in the seat up-down direction guided by the guide face 50.

The slider 52 is capable of sliding along the guide face 50 of the guide section 48 of the base member 46 within a predetermined range toward the seat lower left side (the arrow A direction in FIG. 1 and FIG. 2) and in the opposite direction toward the seat upper right side (the opposite direction to the arrow A direction in FIG. 1 and FIG. 2). In a state in which the slider 52 is disposed at a seat right side end of the permitted slide range of the slider 52 with respect to the guide section 48 of the base member 46 (referred to hereafter simply as the “permitted slide range of the slider 52”), movement of the slider 52 toward the seat right side and movement of the slider 52 in the seat up-down direction is restricted by the guide section 48 of the base member 46. In a state in which the slider 52 is disposed at a seat left side end of the permitted slide range of the slider 52, movement of the slider 52 toward the seat left side and in the seat up-down direction is restricted by the guide section 48 of the base member 46.

The support section 32 is disposed at the seat front side of a seat upper side end portion of the slider 52, and the support section 32 is fixed to the slider 52. Accordingly, the support section 32 is capable of sliding together with the slider 52 toward the seat lower left side (the arrow A direction in FIG. 1 and FIG. 2) and in the opposite direction toward the seat upper right side (the opposite direction to arrow A in FIG. 1 and FIG. 2). The portion of the webbing 20 inside the elongated hole 34 of the support section 32 is moved as a result of the support section 32 sliding together with the slider 52 in this manner.

As described above, the support section 32 is disposed at the seat front side of the seat upper side end portion of the slider 52. Accordingly, a seat lower side face of the support section 32 opposes a seat upper side face of the seatback 16 of the seat 12 along the seat up-down direction. As illustrated in FIG. 2, the shape of the base member 46, the shape of the guide section 48, the shape of the slider 52, the placement position of the base member 46 and so on are set such that, in a state in which the slider 52 is disposed at the seat left side end of the permitted slide range of the slider 52, a seat lower side end of the support section 32 abuts a seat upper side face of the seatback 16, serving as a restriction portion, thereby restricting further sliding of the slider 52 toward the seat left side (more specifically, the seat lower left side).

As illustrated in FIG. 1, the angle of incline θ1 of the guide face 50 of the guide section 48 of the base member 46 with respect to the seat left-right direction is smaller than an angle of incline θ2 of the length direction of the shoulder webbing 20B with respect to the seat left-right direction in a state in which the slider 52 is disposed at the seat right side end of the permitted slide range of the slider 52.

Moreover, in a state in which the slider 52 is disposed at the seat left side end of the permitted slide range of the slider 52, the length of the webbing 20 between the pulley 28 and the tongue 40 engaged with the buckle 42 is shorter than in a state in which the slider 52 is disposed on the seat right side of the seat left side end of the permitted slide range of the slider 52.

The base member 46 includes a spring anchor portion 54. The spring anchor portion 54 is provided at the seat left side of the guide section 48 of the base member 46, and the spring anchor portion 54 is integrally linked to the guide section 48. A compression coil spring 56, serving as an urging section, is provided to the base member 46 between the spring anchor portion 54 and the slider 52. A seat left side end of the compression coil spring 56 is anchored to the spring anchor portion 54 of the base member 46, and a seat right side end of the compression coil spring 56 is anchored to the seat left side end of the slider 52. The slider 52 is urged toward the seat right side by the compression coil spring 56.

Urging force of the compression coil spring 56 is greater than the urging force of the spool urging spring of the spool urging mechanism 22 urging the spool 18 in the take-up direction, at least in the fitted state of the webbing 20 over the body of the occupant 44 (the state illustrated in FIG. 1). Accordingly, in the fitted state of the webbing 20 over the body of the occupant 44 while in a normal state that is not a vehicle emergency, the slider 52 is disposed at the seat right side end of the permitted slide range of the slider 52 with respect to the guide section 48 of the base member 46 (the state illustrated in FIG. 1).

Moreover, the material, wire diameter, number of coils and the like of the compression coil spring 56 are set such that in a state in which the slider 52 is disposed at the seat left side end of the permitted slide range of the slider 52 (namely, a state in which the seat lower side face of the support section 32 abuts the seat upper side face of the seatback 16 acting as a restriction portion) as illustrated in FIG. 2, the urging force of the compression coil spring 56 is not at its greatest, and a coil portion of the compression coil spring 56 is not fully compressed in the axial direction of the compression coil spring 56 (in other words, in the state in which the slider 52 is disposed at the seat left side end of the permitted slide range of the slider 52, the compression coil spring 56 is capable of deforming so as to become even shorter in its axial direction, thereby further increasing the urging force).

### Operation and Advantageous Effects of Present Exemplary Embodiment

In the present exemplary embodiment, the webbing 20 is pulled by the occupant 44 sitting in the seat 12 in order to pull the webbing 20 out from the spool 18 of the webbing take-up device 14. The webbing 20 that has been pulled out in this manner is wrapped over the body of the occupant 44 from the seat front side of the body of the occupant 44. In this state, the tongue 40 provided to the webbing 20 is engaged with the buckle 42, and the tongue 40 is retained by the buckle 42, thereby fitting the webbing 20 over the body of the occupant 44. In this state, the pelvic region of the body of the occupant 44 is restrained by the lap webbing 20A of the webbing 20, and a region of the body of the occupant 44 from the shoulder on the seat right side across the chest to the seat left side of the pelvic region is restrained by the shoulder webbing 20B.

Note that in this state, the slider 52 of the support device 30 slides to the seat right side end of the permitted slide range of the slider 52 with respect to the guide section 48 of the base member 46 as a result of the urging force of the compression coil spring 56. Accordingly, in this state, the support section 32 of the support device 30 moves toward the seat right side, away from the body of the occupant 44 (in particular, the neck of the occupant 44). This thereby enables the shoulder webbing 20B and the support section 32 to be prevented or suppressed from abutting the body of the occupant 44 (in particular, the neck of the occupant 44). This enables the occupant 44 to be prevented or suppressed from experiencing discomfort caused by the shoulder webbing 20B or the support section 32 abutting the neck of the occupant 44.

In the vehicle applied with the seatbelt device 10, the front monitoring device detects the distance to other vehicles or obstacles in front. When the distance to another vehicle or an obstacle in front as detected by the front monitoring device becomes a predetermined value or lower, the ECU determines that a vehicle collision predicted state has arisen, a vehicle collision being one type of vehicle emergency, and the ECU drives forward rotation of the motor 27. The forward rotation drive of the motor 27 actuates the clutch of the rotation force transmission section, and forward rotation drive force of the motor 27 is transmitted to the spool 18. The spool 18 is thereby rotated in the take-up direction, and the webbing 20 is taken up onto the spool 18. Slack in the webbing 20 fitted over the body of the occupant 44 is thereby eliminated.

When the motor 27 is actuated and the webbing 20 is taken up onto the spool 18 in this manner, tension on the webbing 20 increases, at least between the pulley 28 and the tongue 40 engaged with the buckle 42. The tension on the webbing 20 between the pulley 28 and the tongue 40 engaged with the buckle 42 becomes a force acting against the urging force of the compression coil spring 56 of the support device 30. Accordingly, when the motor 27 is actuated, the support section 32 of the support device 30 is pulled toward the seat left side by the webbing 20. The slider 52 of the support device 30 is thereby guided by the guide face 50 of the guide section 48 of the base member 46 of the support device 30 so as to slide toward the seat lower left side (the arrow A direction side in FIG. 1 and FIG. 2) until the slider 52 is disposed at the seat left side end of the permitted slide range of the slider 52.

In this manner, in the state in which the slider 52 of the support device 30 is disposed at the left side end of the permitted slide range of the slider 52, the support section 32 is at its closest to the body of the occupant 44, in particular to the neck of the occupant 44, and the portion of the webbing 20 disposed inside the elongated hole 34 of the support section 32, namely a seat upper side end portion of the shoulder webbing 20B of the webbing 20, is at its closest to the body of the occupant 44, in particular to the neck of the occupant 44. Accordingly, a separation between the seat upper side end portion of the shoulder webbing 20B and the seat left-right direction center of the body of the occupant 44 (the center line C in FIG. 2) becomes narrower, enabling the performance when restraining the body of the occupant 44 with the shoulder webbing 20B to be improved. In particular, the body of the occupant 44 can be effectively suppressed from moving toward the seat right side, and the body of the occupant 44 can be effectively suppressed from approaching interior vehicle components or the like provided on the seat right side of the body of the occupant 44.

Moreover, as illustrated in FIG. 2, when the slider 52 is disposed at the seat left side end of the permitted slide range of the slider 52, the seat lower side face of the support section 32 abuts the seat upper side face of the seatback 16 of the seat 12. Accordingly, even if the body of the occupant 44 pulls on the webbing 20 when attempting to move toward the seat front side under inertia, the support section 32 is prevented or suppressed from being displaced toward the seat lower side by the guide section 48 of the base member 46 and by the seatback 16. This thereby enables the performance of the shoulder webbing 20B when restraining the body of the occupant 44 to be further improved.

Moreover, as illustrated in FIG. 2, the angle of incline θ1 of the guide face 50 of the guide section 48 of the base member 46 with respect to the seat left-right direction is set to less than 45°. Accordingly, the movement amount of the slider 52 toward the seat left side when guided by the guide face 50 is larger than the movement amount of the slider 52 in the seat up-down direction when guided by the guide face 50. Accordingly, when the slider 52 is guided by the guide face 50 such that the support section 32 slides toward the seat lower left side (the arrow A direction side in FIG. 1 and FIG. 2), the movement amount of the support section 32 toward the seat left side is greater than the movement amount of the support section 32 toward the seat lower side. Moreover, the angle of incline θ1 of the guide face 50 of the guide section 48 of the base member 46 with respect to the seat left-right direction is smaller than the angle of incline θ2 of the length direction of the shoulder webbing 20B with respect to the seat left-right direction prior to the slider 52 sliding toward the seat lower left side.

Accordingly, an angle of incline θ3 (see FIG. 2) of the length direction of the shoulder webbing 20B with respect to the seat left-right direction in a state after the slider 52 has slid toward the seat lower left side is larger than the angle of incline θ2 (see FIG. 1) of the length direction of the shoulder webbing 20B with respect to the seat left-right direction in a state prior to the slider 52 sliding toward the seat lower left side. The angle of incline θ3 is close to being a right angle. This thereby enables the performance of the shoulder webbing 20B when restraining the body of the occupant 44 to be further improved.

The slider 52 to which the support section 32 is fixed slides as a result of the tension on the webbing 20 when the tension has been increased by actuation of the motor 27. Moreover, the tension on the webbing 20 increased by actuation of the motor 27 is capable of releasing the retention of the slider 52 at the seat right side end of the permitted slide range of the slider 52. A dedicated drive section such as a motor solely for the purpose of moving the slider 52, and a dedicated configuration for releasing the retention of the slider 52 at the seat right side end of the permitted slide range of the slider 52, are thus rendered unnecessary, enabling costs to be lowered while suppressing a delay in the movement of the slider 52 with respect to actuation of the motor 27.

Moreover, the guide face 50 of the guide section 48 of the base member 46 that guides the slider 52 is configured by a flat inclined face displaced toward the seat lower side on progression toward the seat left side. Accordingly, the slider 52 slides along a linear path, with no significant change in the slide direction of the slider 52 partway through sliding. Accordingly, the slider 52 is capable of sliding smoothly toward the seat left side end of the permitted slide range when the tension on the webbing 20 is increased by actuation of the motor 27.

Moreover, the motor 27 is stopped if a vehicle collision is avoided, for example by the vehicle being operated by the occupant 44. When the motor 27 is stopped, the coupling between the output shaft of the motor 27 and the spool 18 by the clutch of the rotation force transmission section is disengaged. In this state, the only force attempting to rotate the spool 18 in the take-up direction is that coming from the spool urging spring of the spool urging mechanism 22. The urging force of the compression coil spring 56 is greater than the urging force of the spool urging spring of the spool urging mechanism 22 that urges the spool 18 in the take-up direction, at least in the fitted state of the webbing 20 over the body of the occupant 44 (the state illustrated in FIG. 1). Accordingly, in this state, the slider 52 slides to the seat right side end of the permitted slide range of the slider 52 under the urging force of the compression coil spring 56 (the state illustrated in FIG. 1). Accordingly, when a vehicle collision has been avoided and a normal travel state is restored, the support section 32 of the support device 30 can be moved toward the seat right side, away from the body of the occupant 44 (in particular, the neck of the occupant 44).

The guide face 50 of the guide section 48 is configured by a flat inclined face displaced toward the seat lower side on progression toward the seat left side. Accordingly, the slider 52 slides along a linear path, with no significant change in the slide direction of the slider 52 partway through sliding. Accordingly, the slider 52 is capable of sliding smoothly toward the seat right side end of the permitted slide range under the urging force of the compression coil spring 56.

When the slider 52 reaches the seat left side end of the permitted slide range, the seat lower side face of the support section 32 of the support device 30 abuts the seat upper side face of the seatback 16 acting as a restriction portion. Accordingly, the slider 52 is restricted from sliding any further toward the seat left side (more specifically, the seat lower left side). Note that in the state in which the slider 52 has reached the seat left side end of the permitted slide range, the urging force of the compression coil spring 56 is not at its greatest, and the coil portion of the compression coil spring 56 is not fully compressed in the axial direction of the compression coil spring 56.

Namely, in the present exemplary embodiment, in the state in which the slider 52 has reached the seat left side end of the permitted slide range, the compression coil spring 56 is still capable of elastically deforming when compressed along the axial direction of the compression coil spring 56. For example, this enables the compression coil spring 56 to be suppressed from reaching its elastic deformation limit due to compression along its axial direction when the slider 52 reaches the seat left side end of the permitted slide range. Accordingly, when the increase in tension on the webbing 20 caused by actuation of the motor 27 is released, the slider 52 is capable of sliding toward the seat right side end of the permitted slide range of the slider 52 under the urging force of the compression coil spring 56.

In a vehicle emergency such as a vehicle collision, the locking mechanism 24 is actuated, thereby preventing or suppressing the webbing 20 from being pulled out from the spool 18. Accordingly, the webbing 20 can effectively suppress the occupant 44 from moving toward the seat front side under inertia in a vehicle emergency. Moreover, in a vehicle emergency such as a vehicle collision, the pre-tensioner 26 is actuated, thereby rotating the spool 18 in the take-up direction. The webbing 20 is thereby taken up onto the spool 18, eliminating slack in the webbing 20 fitted over the body of the occupant 44. The body of the occupant 44 can thus be more firmly restrained by the webbing 20, enabling the webbing 20 to even more effectively suppress the occupant 44 from moving toward the seat front side under inertia.

Moreover, when the pre-tensioner 26 is actuated and the webbing 20 is taken up by onto the spool 18, the tension on the webbing 20 increases, at least between the pulley 28 and the tongue 40 engaged with the buckle 42. The tension on the webbing 20 between the pulley 28 and the tongue 40 engaged with the buckle 42 becomes a force acting against the urging force of the compression coil spring 56 of the support device 30. Accordingly, when the pre-tensioner 26 is actuated, the support section 32 of the support device 30 is pulled toward the seat left side by the webbing 20.

Accordingly, the slider 52 of the support device 30 is guided by the guide face 50 of the guide section 48 of the base member 46 of the support device 30 and slides toward the seat lower left side (the arrow A direction side in FIG. 1 and FIG. 2) until the slider 52 is disposed at the seat left side end of the permitted slide range. Accordingly, actuation of the pre-tensioner 26 enables similar advantageous effects to be obtained to cases in which the spool 18 is rotated in the take-up direction by forward rotation drive force of the motor 27 when the motor 27 is actuated.

Note that in the present exemplary embodiment, the guide face 50 of the guide section 48 of the base member 46 that guides the slider 52 is configured by a flat inclined face displaced toward the seat lower side on progression toward the seat left side. However, the guide face 50 of the guide section 48 is not limited to being configured by a flat face. It is sufficient that the guide face 50 of the guide section 48 be capable of guiding the slider 52 with no significant change in the slide direction of the slider 52 partway through sliding. Accordingly, for example, the guide face 50 of the guide section 48 may be configured by a curved inclined face displaced toward the seat lower side on progression toward the seat left side.

In the present exemplary embodiment, in the state in which the slider 52 is disposed at the seat left side end of the permitted slide range of the slider 52, the seatback 16 configures a restriction portion for restricting further movement of the slider 52 toward the seat left side. However, the restriction portion may, for example, be a restriction member that restricts further movement of the slider 52 toward the seat left side by abutting either the slider 52 or the guide section 48 from the seat left side in the state in which the slider 52 is disposed at the seat left side end of the permitted slide range of the slider 52. Namely, there is no limitation to the specific configuration of the restriction portion, as long as the restriction portion is capable of restricting further movement of the slider 52 toward the seat left side in the state in which the slider 52 is disposed at the seat left side end of the permitted slide range of the slider 52.

Moreover, in the present exemplary embodiment, the urging section for urging the slider 52, to which the support section 32 of the support device 30 is fixed, toward the seat right side (one width direction side of the seat) is configured by the compression coil spring 56. However, the urging section may be configured by a tension coil spring that is provided on the seat right side of the slider 52 and urges the slider 52 toward the seat right side, or the urging section may be configured by a plate spring or a torsion coil spring that is provided at an appropriate position with respect to the slider 52 and urges the slider 52 toward the seat right side. Namely, a wide range of configurations may be applied as the urging section with no particular limitation to the specific configuration, as long as the urging section is capable of directly or indirectly urging the support section 32 of the support device 30 toward the seat right side (one width direction side of the seat).

In the present exemplary embodiment, in the state in which the slider 52, to which the support section 32 of the support device 30 is fixed, is disposed at the seat left side end of the permitted slide range of the slider 52, the urging force of the compression coil spring 56 is not at its greatest, and the coil portion of the compression coil spring 56 is not fully compressed along the axial direction of the compression coil spring 56. However, the urging section may be configured such that the urging force of the urging section is at its greatest in the state in which movement of the support section toward the seat left side (other width direction side of the seat) is restricted.

Moreover, in the present exemplary embodiment, the slider 52 to which the support section 32 is fixed is moved toward the seat left side by the tension on the webbing 20 being increased as a result of actuation of the motor 27 or the pre-tensioner 26. However, the slider 52 may slide toward the seat left side as a result of drive force of a drive section such as a motor or solenoid. Alternatively, instead of the compression coil spring, an urging spring may be provided to urge the slider toward the seat left side, and a retention portion may be provided to retain the slider 52 in a state in which the slider 52 is disposed at the seat right side end of the permitted slide range of the slider 52, with the retention of the slider 52 by the retention portion being released in a vehicle emergency, such that the slider 52 slides toward the seat left side as a result of the urging force of the urging spring. Namely, a wide range of configurations may be applied as a configuration to slide the slider 52, with no particular limitation thereto.

Moreover, in the present exemplary embodiment, in the fitted state of the webbing 20 over the body of the occupant 44, part of the webbing 20 configures the shoulder webbing 20B, and another part of the webbing 20 configures the lap webbing 20A. However, configuration may be made such that lap webbing 20A is not configured by any part of the webbing 20 in the fitted state of the webbing 20 over the body of the occupant 44.

Moreover, in the present exemplary embodiment, the webbing take-up device 14 is provided inside the seatback 16 of the seat 12. However, the webbing take-up device 14 may be provided at a seat rear side of the seatback 16, at a seat left-right direction side of the vehicle seat 12, or to a vehicle ceiling. Namely, there is no particular limitation to the placement position of the webbing take-up device 14.

Moreover, in the present exemplary embodiment, in cases in which a vehicle collision has been avoided, the motor 27 is stopped, and the coupling of the output shaft of the motor 27 to the spool 18 by the clutch of the rotation force transmission section is disengaged. However, for example, configuration may be made such that in cases in which a vehicle collision has been avoided, the motor 27 is driven in reverse, such that the spool 18 is rotated in the pull-out direction, and the webbing 20 is pulled out from the spool 18 by the support section 32 of the support device 30 moving together with the slider 52 under the urging force of the compression coil spring 56.

Moreover, the present exemplary embodiment includes the pre-tensioner 26 and the motor 27. However, configuration may be made in which only one out of the pre-tensioner 26 or the motor 27 is provided.

Moreover, in the present exemplary embodiment, a vehicle collision and a predicted vehicle collision are both examples of a vehicle emergency. However, configuration may be made in which either one of a vehicle collision or a predicted vehicle collision configures a vehicle emergency. Alternatively, another state that is neither a vehicle collision nor a predicted vehicle collision may configure a vehicle emergency.

Moreover, in the present exemplary embodiment, the seat upper side end portion of the shoulder webbing 20B is disposed at the seat upper side of the seat right side of the seatback 16 of the vehicle seat 12. However, the seat upper side end portion of the shoulder webbing 20B may be disposed at the seat upper side of the seat left side of the seatback 16 of the vehicle seat 12. In such a configuration, the webbing take-up device 14, the pulley 28, the support device 30, the anchor plate 36, the buckle 42, and the like are disposed with inverted placement in the seat left-right direction with respect to the present exemplary embodiment.

The disclosure of Japanese Patent Application No. 2016-96396, filed on May 12, 2016, is incorporated in its entirety by reference herein.

1. A seatbelt device comprising:
a shoulder webbing that spans from an upper side on one width direction side of a seat of a vehicle to a lower side on another width direction side of the seat in a fitted state of the shoulder webbing over the body of an occupant;
a support section that supports an upper side end portion of the shoulder webbing at the upper side on the one width direction side of the seat; and
a guide section that includes a flat or curved guide face inclined toward the lower side on progression from the one width direction side toward the other width direction side, that is configured so as to enable the support section to move back and forth along the guide face, and that is configured such that the support section moves toward the other width direction side in a vehicle emergency.

2. The seatbelt device of claim 1, wherein the support section is moved toward the other width direction side by increased tension on the shoulder webbing in a vehicle emergency, and the support section is subsequently moved toward the one width direction side by a reduction in the tension on the shoulder webbing that was increased in the vehicle emergency.

3. The seatbelt device of claim 1, wherein:
the support section is urged toward the one width direction side by urging force of an urging section and retained at the upper side on the one width direction side of the seat; and
the support section is moved toward the other width direction side by being applied with a force acting against the urging force of the urging section, and moved toward the one width direction side by the urging force of the urging section when the force is released.

4. The seatbelt device of claim 3, wherein:
the urging force of the urging section is increased by moving the support section toward the other width direction side, and
the support section is restricted from moving toward the other width direction side before the urging force of the urging section is at its greatest.
